(19) United States
(12) Patent Application Publication
(10) Pub. No.: US 2019/0123789 A1
(43) Pub. Date: Apr. 25, 2019

(54) METHOD FOR GROUPING USERS BASED ON OUT-OF-BAND SPATIAL INFORMATION IN MULTI-USER MILLIMETER WAVE SYSTEM

(71) Applicant: University of Electronic Science and Technology of China, Chengdu (CN)

(72) Inventors: Binrui LI, Chengdu (CN); Zhongpei ZHANG, Chengdu (CN); Beilin YAO, Chengdu (CN)

(21) Appl. No.: 15/978,077

(22) Filed: May 11, 2018

(30) Foreign Application Priority Data
Oct. 24, 2017 (CN) 201711000225.7

(51) Int. Cl. H04B 7/0452; H04B 7/06

(52) U.S. Cl. CPC H04B 7/0452; H04B 7/0626

(57) ABSTRACT

The present invention belongs to the technical field of wireless communication, and particularly relates to a method for grouping users based on out-of-band spatial information in a multi-user millimeter wave system. By a grouping strategy, the out-of-band spatial information is fully utilized and the search range is narrowed on the base station side to perform beam search within a more accurate initial range. On the user side, the number of receiving beam search times is reduced and the energy consumption is saved for users by a strategy that search subframes which are not in the group keep mute. In the feedback process, the user side just needs to feed back beam matching information within search subframes corresponding to the group. The disadvantage that more redundant information is fed back in a traditional search method is overcome, so the feedback overhead is reduced and the system efficiency is improved.

### TECHNICAL FIELD

The present invention belongs to the technical field of wireless communication, and relates to Millimeter Wave (mmWave) communication, beam selection and Multiple Input Multiple Output (MIMO) technologies, and in particular to a method for grouping users based on out-of-band spatial information in a multi-user millimeter wave system.

### BACKGROUND OF THE PRESENT INVENTION

With the development of wireless communication, Millimeter Wave (mmWave) is considered as one of core technology candidates of the next generation wireless communication technologies and can greatly broaden available spectrum resources. However, compared with the traditional microwave frequency, the key challenge of using the millimeter wave bands is its severe signal propagation loss. In order to compensate for such loss, large antenna arrays can be used to realize high power gain. Fortunately, since the wavelength of millimeter wave signals is small, these arrays can be packaged in small areas of transmitters and receivers. For such a millimeter wave system, Channel State Information (CSI) is crucial to effective communication and the design of precoders. However, a large Multiple Input Multiple Output (MIMO) channel matrix is generated by the use of large antenna arrays. Since there are a great number of channel parameters to be estimated, channel estimation in the millimeter wave system is very challenging. In addition, a method for obtaining a digital sample from each antenna is generally infeasible due to high frequency. To solve this problem of high-frequency sampling, analog beamforming has been proposed. The main idea of analog beamforming is to control the phase of signals transmitted or received by each antenna by an analog phase-shifter network.

By analog beamforming, the most direct channel estimation is to perform exhaustive search in all possible angles and directions. Specifically, a system having N transmitting antennas and N receiving antennas is considered. If the purpose is to achieve a minimum angular resolution of it/N on the transmitter and receiver sides, exhaustive channel estimation based on search needs a set of N transmit beamforming vectors at the transmitter to span all possible beam directions, and also needs N receive beamforming vectors at the receiver. A matrix with a dimension of N×N may be formed by searching all possible combinations, where the N×N represents channel gain between N transmitting beams and N receiving beams. The matrix is generally called a virtual channel matrix. Although the input of the millimeter wave MIMO channel matrix is expected to be large, it has been indicated by recent measurements that millimeter wave channels show the propagation characteristic of sparsity in the angle domain. That is, there are only several main propagation paths in the millimeter wave channels. Such sparsity may be observed in the virtual channel matrix, since only a limited number of transmitting and receiving direction pairs have non-zero gain. Therefore, the main purpose of millimeter wave channel estimation is to identify these paths, so that the transceiver may be aligned with transmitting and receiving beams along these paths.

At present, some channel estimation algorithms based on compressed sensing by channel sparsity in the millimeter wave system have been proposed. Among these algorithms, some basic ideas are to search multiple transmitting/receiving directions in each measurement by creating an initial beam pattern. The angle range in these algorithms is wider than that for exhaustive search. A similar adaptive beamforming algorithm and a multi-stage codebook algorithm are proposed. By subarrays and antenna deactivation (turnoff), such a hierarchical codebook may be obtained by a single Radio Frequency (RF) chain. By a wider initial beam pattern, the multi-stage codebook algorithm can reduce the number of measurements required by channel estimation. However, it introduces loss of directional gain, which results in lower Signal-to-Noise Ratio (SNR) and higher estimation error probability at the receiver. In this sense, there is a challenging tradeoff between the time consumption and the accuracy of millimeter wave channel estimation.

Sparse millimeter wave channels are estimated by a search algorithm similar to “binary search” at the beginning of the multi-stage codebook algorithm. In each stage of the algorithm, the estimated ranges of an Angle of departure (AOD) and an Angle of Arrival (AOA) are divided into multiple subranges. The algorithm requires the estimation time proportional to each estimated path. Although there is significant improvement compared with exhaustive search, such a channel estimation algorithm may be not sufficient to track the fast channel change, especially for millimeter wave channels with parameters changing fast. In addition, it may be unnecessary to perform so many measurements at high SNR, which results in unnecessary delay. While there is a problem in the initial search stage that the low received SNR ratio affects signal estimation.

### SUMMARY OF THE PRESENT INVENTION

The purpose of the present invention is to provide a method for grouping users based on out-of-band spatial information, to solve problems of high energy and time consumption of the multi-user beam selection process in the multi-user millimeter wave system and too low received signal-to-noise ratio in the initial beam search stage.

The present invention employs the following technical solution.

For the convenience of distinguishing, in the following solution, parameters of the microwave system are underlined in order to distinguish them from parameters of the millimeter wave system. The same is also applicable to the following description.

A method for grouping users based on out-of-band spatial information in a multi-user millimeter wave system is provided. The method assists in establishing millimeter wave links by spatial information of a microwave system, comprising the following steps.

S1: Acquisition of uplink channel information: an uplink channel matrix of a microwave system of all users is obtained on the base station side by mature channel estimation, for example, an LS estimation algorithm based on pilot training:

H=[h₁,h₂. . . hᵢ. . . h_{K}]∈C^{N}^{_{BS}}^{×K},

where, hᵢ represents the i^{th} microwave channel, where i=1, . . . , K, and the dimension of the i^{th} microwave channel is N_{BS}×1, where N_{BS} is the number of base stations; and H represents a microwave channel matrix with a dimension of N_{BS}×K.

S2: Transformation of spatial information: an out-of-band spatial information matrix is calculated according to the channel matrix by the following formula:

H^{SI}=FH=[h₁^{SI},h₂^{SI}. . . hᵢ^{SI}. . . h_{K}^{SI}]∈C^{N}^{_{BS}}^{×K}

where, h^{SI} represents a channel for the i^{th} microwave out-of-band space, where i=1, . . . , K, and the dimension of the channel is N_{BS}×1, where N_{BS} is the number of base stations; F is a DFT matrix with a dimension of N_{BS}×N_{BS}; and H^{SI} is a channel matrix for the microwave out-of-band space, with a dimension of N_{BS}×K.

S3: Grouping of users: the grouping result may be directly used for the millimeter wave system, since the maximum superscript of spatial gain of the microwave system is approximately equal to that of the millimeter wave system. The maximum superscript information of spatial gain of each user is calculated by the following formula:

hᵢ^{idx}=arg max(hᵢ^{SI}) i∈1,2, . . . K

where, argmax represents to find a parameter with the maximum score.

All users with an equal maximum superscript are put into one group according to the maximum superscript information of the spatial gain of each user, to form N_{BS} groups in total which are donated as large beam domain groups

.Gₙ(n=1,2 . . . N_{BS})={hᵢ^{idx}×n|i∈1,2, . . . K}.

Meanwhile, it is to be noted that each group corresponds to a large beam domain. The large beam may cover fine beams formed by several millimeter wave systems, so these large beam domains will be refined during the subsequent beam search and thus finer beams are found for matching.

S4: Search of beams: polling search is performed by time division according to the grouping information. In the beam search stage of the base station of the millimeter wave system, it is divided into N_{BS} subframes as shown in FIG. 4, exhaustive search is performed within each subframe and only N_{BS}/N_{BS} searches are needed within each subframe; and binary search may be also used within subframes and the specific method is not limited in the present invention.

S5: Feedback of information from users: during the frame-by-frame search performed by a base station, only users in a group perform matching search for receiving beams by exhaustive search, while users not in the group keep mute and don't perform search for receiving beams and subsequent beam selection algorithms. Feedback from users may be fed back timely by uplink channels of the microwave system. In the feedback process, since only the search matching result within the group is retained, it may be considered to crop useless or redundant information in the traditional algorithm, so that the energy consumption and the feedback overhead are reduced for users and the system efficiency is improved.

S6: Transmission of data in groups: after information fed back by all users is obtained in the step S5, each user group is subgrouped in the following way:

first, determining the number M_{RF} of RFs configured by the millimeter wave system of the base station, and keeping the number of subgroups equal to the number M_{RF} of RFs; and then, setting the maximum value of vectors in the information fed back by each user as 0, performing a correlation operation by the modified vectors, putting users corresponding to a set of vectors with the highest correlation value into a first subgroup by the greedy algorithm and putting users with the maximum correlation value among the remaining correlation values into a second subgroup, and so on, until the number of subgroups reaches the maximum value or users are all grouped.

During the data transmission, the strategy of transmission in groups in the large beam domain is still used. During each transmission, a user is randomly selected from M_{RF} subgroups and allocated with an RF link for data transmission. This may effectively eliminate the interference between users.

The present invention has the following beneficial effects:

by introducing the out-of-band spatial information, the low received signal-to-noise ratio in the initial beam search stage of the millimeter wave system and the high estimation error probability which may be caused by the former are effectively avoided;

by a grouping strategy, the out-of-band spatial information is fully utilized and the search range is narrowed on the base station side to perform beam search within a more accurate initial range; on the user side, the number of receiving beam search times is reduced and the energy consumption is saved for users by a strategy that search subframes which are not in the group keep mute;

also, by the grouping strategy, in the feedback process, the user side just needs to feed back beam matching information within search subframes corresponding to the group, and the disadvantage that more redundant information is fed back in a traditional search method is overcome, so the feedback overhead is reduced and the system efficiency is improved; and

related subgrouping methods are used in the data transmission stage to reduce the interference between users.

### BRIEF DESCRIPTION OF THE DRAWINGS

FIG. 1 is a block diagram of a multi-user multi-wideband MIMO system.

FIG. 2 is a diagram of an all-digital beamforming microwave transceiver system.

FIG. 3 is a diagram of an analog beamforming millimeter wave transceiver system.

FIG. 4 is a structure diagram of frames in a beam search stage.

### DETAILED DESCRIPTION OF THE PRESENT INVENTION

The technical solution of the present invention will be further described below in detail with reference to the drawings by embodiments.

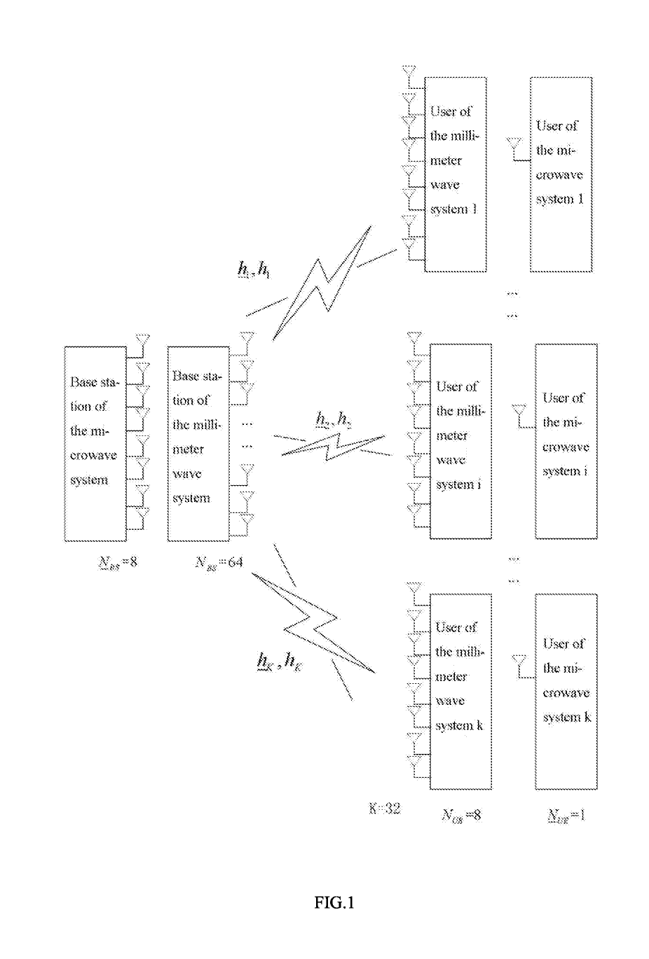

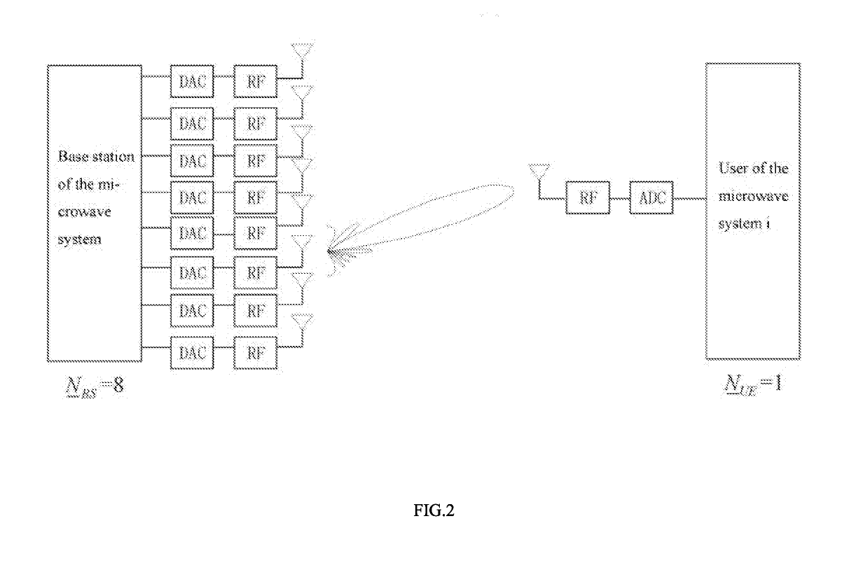

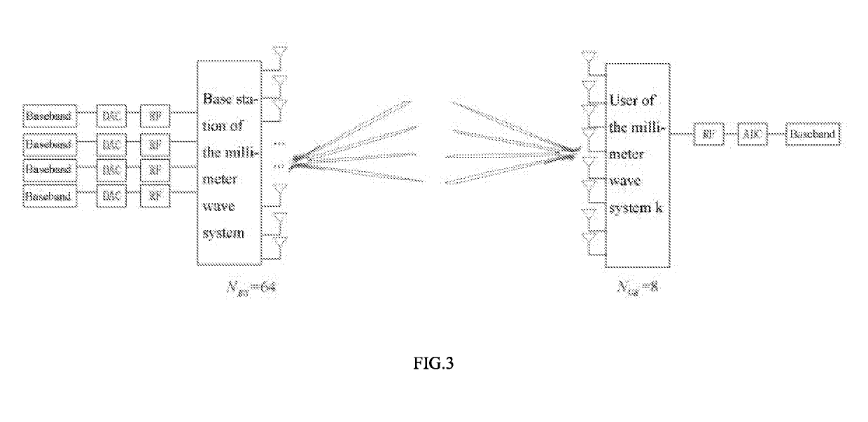

The solution of the present invention is applied to a multi-wideband MIMO system as shown in FIG. 1. Considering that the received signal-to-noise ratio in the initial beam search stage in a multi-stage codebook algorithm is too low at present, in the present invention, spatial information of a microwave system is used to assist in establishing millimeter wave links, especially to find an optimal transceiver beam pair for an analog or hybrid beamforming millimeter wave system. Since the microwave system is not equipped with any large antenna array, it is assumed that the microwave system has narrow-band MIMO channels and is of a traditional all-digital structure. Both the microwave system and the millimeter wave system use uniform linear arrays on the receiving and transmitting sides. For ease of description, taking specific systems shown in FIGS. 2 and 3 for example, a base station of the microwave system is equipped with N_{BS}=8 antennas, a base station of the millimeter wave system is equipped with N_{BS}=64 antennas, and K=32 users are equipped with N_{UE}=1 microwave antenna and N_{UE}=8 millimeter wave antennas, respectively. Assumed that the microwave system and the millimeter wave system can communicate with each other, for example, the two systems are deployed similarly on the base station side where the positional difference may be ignored, and exchange data via a high-speed interface, while it is assumed that the two systems are designed integrally on the user side and thus share information.

A method for grouping users based on out-of-band spatial information in a multi-user millimeter wave system is provided. The method assists in establishing millimeter wave links by spatial information of a microwave system, comprising the following steps.

S1: Acquisition of uplink channel information: an uplink channel matrix of a microwave system of all users is obtained on the base station side by mature channel estimation, for example, an LS estimation algorithm based on pilot training: H=[h₁,h₂ . . . hᵢ . . . h₃₂]∈C^{8×32},

where, hᵢ represents the i^{th} microwave channel, where i=1, . . . , 32, and the dimension of the i^{th} microwave channel is 8×1; and H represents a microwave channel matrix with a dimension of 8×32.

S2: Transformation of spatial information: an out-of-band spatial information matrix is calculated according to the channel matrix by the following formula:

H^{SI}=FH=[h₁^{SI},h₂^{SI} . . . hᵢ^{SI} . . . h₃₂^{SI}]∈C^{8×32}

where, h^{SI} represents a channel for the i^{th} microwave out-of-band space, where i=1, . . . , 32, and the dimension of the channel is 8×1; F is a DFT matrix with a dimension of 8×8; and H^{SI} is a channel matrix for the microwave out-of-band space, with a dimension of 8×32.

S3: Grouping of users: the grouping result may be directly used for the millimeter wave system, since the maximum superscript of spatial gain of the microwave system is approximately equal to that of the millimeter wave system. The maximum superscript information of spatial gain of each user is calculated by the following formula:

hᵢ^{idx}=arg max(hᵢ^{SI}), i∈1,2, . . . 32

where, argmax represents to find a parameter with the maximum score.

All users with an equal maximum superscript are put into one group according to the maximum superscript information of the spatial gain of each user, to form 8 groups in total which are donated as large beam domain groups

Gₙ(n=1,2 . . . ,8)={hᵢ^{idx}=n|i∈1,2 . . . 32}.

Meanwhile, it is to be noted that each group corresponds to a large beam domain. The large beam may cover fine beams formed by several millimeter wave systems, so these large beam domains will be refined during the subsequent beam search and thus finer beams are found for matching.

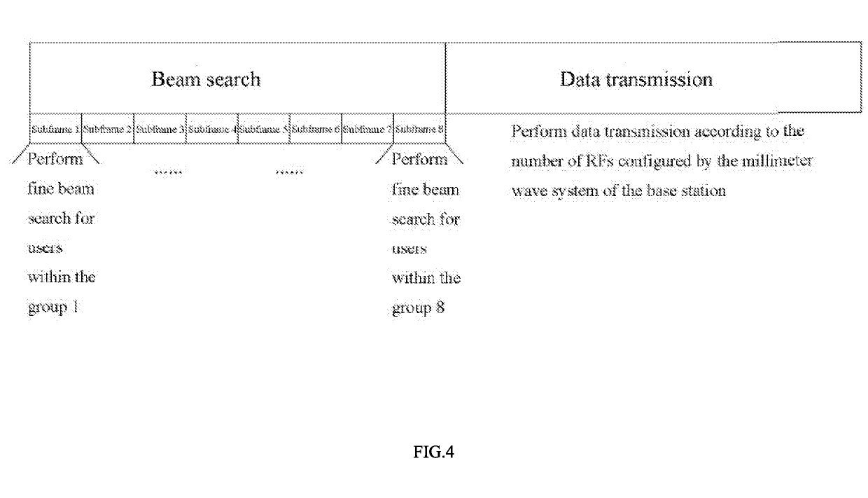

S4: Search of beams: polling search is performed by time division according to the grouping information. In the beam search stage of the base station of the millimeter wave system, it is divided into 8 subframes as shown in FIG. 4, exhaustive search is performed within each subframe and only 8 searches are needed within each subframe; and binary search may be also used within subframes and the specific method is not limited in the present invention.

S5: Feedback of information from users: during the frame-by-frame search performed by a base station, only users in a group perform matching search for receiving beams by exhaustive search, while users not in the group keep mute and don't perform search for receiving beams and subsequent beam selection algorithms. Feedback from users may be fed back timely by uplink channels of the microwave system. In the feedback process, since only the search matching result within the group is retained, it may be considered to crop useless or redundant information in the traditional algorithm, so that the energy consumption and the feedback overhead are reduced for users and the system efficiency is improved.

S6: Transmission of data in groups: after information fed back by all users is obtained in the step S5, each user group is subgrouped in the following way:

first, determining the number 64 of RFs configured by the millimeter wave system of the base station, and keeping the number of subgroups equal to the number 64 of RFs; and then, setting the maximum value of vectors in the information fed back by each user as 0, performing a correlation operation by the modified vectors, putting users corresponding to a set of vectors with the highest correlation value into a first subgroup by the greedy algorithm and putting users with the maximum correlation value among the remaining correlation values into a second subgroup, and so on, until the number of subgroups reaches the maximum value or users are all grouped.

During the data transmission, the strategy of transmission in groups in the large beam domain is still used; during each transmission, a user is randomly selected from 64 subgroups and allocated with an RF link for data transmission. This may effectively eliminate the interference between users.

What is claimed is:

1. A method for grouping users based on an out-of-band spatial information in a multi-user millimeter wave system, the method assisting in establishing millimeter wave links by spatial information of a microwave system, comprising the following steps:
S1: acquisition of uplink channel information: obtaining an uplink channel matrix of a microwave system of all users on the base station side by channel estimation:
H=[h₁,h₂ . . . hᵢ . . . h_{K}]∈C^{N}^{_{BS}}^{×K};
where, hᵢ represents the i^{th} microwave channel, where i=1, . . . , K, and the dimension of the i^{th} microwave channel is N_{BS}×1, where N_{BS} is the number of base stations; and H represents a microwave channel matrix with a dimension of N_{BS}×K;
S2: transformation of spatial information: calculating an out-of-band spatial information matrix according to the uplink channel matrix obtained in the step S1 by the following formula:
H^{SI}=FH=[h₁^{SI},h₂^{SI} . . . hᵢ^{SI} . . . h_{K}^{SI}]∈C^{N}^{_{BS}}^{×K}
where, h^{SI} represents a channel for the i^{th} microwave out-of-band space, where i=1, . . . , K, and the dimension of the channel is N_{BS}×1, where N_{BS} is the number of base stations; F is a DFT matrix with a dimension of N_{BS}×N_{BS}; and H^{SI} is a channel matrix for the microwave out-of-band space, with a dimension of N_{BS}×K;
S3: grouping of users: calculating maximum superscript information of spatial gain of each user by the following formula:
hᵢ^{idx}=arg max(hᵢ^{SI}) i∈1,2, . . . K
where, arg max represents to find a parameter with the maximum score,
putting all users with an equal maximum superscript into one group according to the maximum superscript information of the spatial gain of each user, to form N_{BS} groups in total which are donated as large beam domain groups
└Gₙ(n=1,2 . . . N_{BS})={hᵢ^{idx}×n|i∈1,2, . . . K};
S4: search of beams: performing polling search by time division according to the grouping information;
S5: feedback of information from users: during the frame-by-frame search performed by a base station, for only users in a group, performing matching search for receiving beams by exhaustive search, while for users not in the group, keeping mute and not performing search for receiving beams and subsequent beam selection algorithms;
S6: transmission of data in groups: subgrouping each user group after obtaining information fed back by all users in the step S5 in the following way:
first, determining a number M_{RF} of RFs configured by the millimeter wave system of the base station, and keeping the number of subgroups equal to the number M_{RF} of RFs; and then, setting the maximum value of vectors in the information fed back by each user as 0, performing a correlation operation by the modified vectors, putting users corresponding to a set of vectors with the highest correlation value into a first subgroup by the greedy algorithm and putting users with the maximum correlation value among the remaining correlation values into a second subgroup, and so on, until the number of subgroups reaches the maximum value or users are all grouped.
